(19) United States
(12) Patent Application Publication
(10) Pub. No.: US 2007/0064256 A1
(43) Pub. Date: Mar. 22, 2007

(54) Image forming apparatus

(76) Inventor: Masanori Tanaka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/521,564

(22) Filed: Sep. 15, 2006

(30) Foreign Application Priority Data
Sep. 16, 2005 (JP) 2005-270677

(51) Int. Cl. G06F 3/12

(52) U.S. Cl. 358/1.13; 358/474

(57) ABSTRACT

An image forming apparatus is disclosed. The image forming apparatus includes: an image reading unit configured to read an image from a document; a read mode setting receiving unit configured to receive setting of a read mode; and a read area change unit configured to change an area of the document from which the image reading unit reads an image based on the setting of the read mode.

### BACKGROUND OF THE INVENTION

1. Field of the Invention

The present invention generally relates to an image forming apparatus. More particularly, the present invention relates to an image forming apparatus that can change a reading area for reading a document and change an output area for outputting an image.

2. Description of the Related Art

In a copying machine, that is an image forming apparatus, adopting an inkjet recording scheme, for example, the speed of copying largely varies according to an amount of data scanned by a reading unit. That is, when an effective area of data for the reading unit is large, the speed of printing drops down. When the effective area of data for the reading unit is small, the speed of printing increases. As a method of automatically detecting the effective area when reading a document, there are a method for removing isolated points, and a method for automatically optimizing reading density, and the like. In the following, some examples of conventional techniques relating to improving the printing speed are described.

Japanese Laid-Open Patent application No. 05-14610 discloses an image input/output apparatus in which time for reading and transferring image data is reduced by changing read scanning of image data according to a magnification ratio and a transferring destination of the image data. A reading sensor of the image input/output apparatus includes one-dimensionally arranged reading elements having a narrow reading width with respect to a document width. The reading sensor scans the document in a main scanning direction and in a subscanning direction so as to read the document image. At this time, the image data read by the reading sensor is scaled according to a magnification ratio set by a setting unit for setting the magnification ratio of the document image data. In a facsimile sending mode, the image input/output apparatus reads the document while keeping the scanning amount by the reading sensor to be constant irrespective of the magnification ratio.

Japanese Laid-Open Patent Application No. 07-214762 discloses an inkjet printer that supports a super-fine mode and a fine mode used for facsimile communication and that can increase printing speed. A data reading unit determines whether input printing data is for the super-fine mode or the fine mode. Then, a switching unit switches a send control unit and a head driving control unit between a high speed mode or a low-speed mode according to the judgment. When the mode is the low-speed mode, odd dots are printed in outward scanning and even dots are printed in homeward scanning. In the high speed mode, one line is printed in one-way scanning. Nozzles of the inkjet print head are placed at intervals of 1/7.7 mm. The length of a nozzle line in the subscanning direction is doubled compared to the past. In the fine mode, when the high speed mode is selected, printing can be performed in half time.

Japanese Laid-Open Patent Application No. 11-138790 discloses a method for operating an inkjet copying machine for performing optimal printing by reading a document beforehand. This method is for improving printing performance by identifying a white space area beforehand. The document image is scanned at high speed with low resolution for specifying the white space area beforehand. When the size of the specified white space area is enough, a print head is controlled so as to skip the white space area. This method can be also applied to a non-halftone or non-color portions of an original image. For example, when copying a document, a non-effective recording area (white space area) is determined by pre-scanning the document with a scanner. Accordingly, printing in the outside of the effective area can be skipped. When this method is applied to a case in which large number of copies are made, the speed of copying can be increased without increasing cost.

However, there are following problems in the conventional printing speed improving methods. The printing speed is lowered in usage in which only several pages are output. In addition, since an expensive determination circuit is necessary, the method cannot be applied to a low priced product. Further, since fine adjustment is necessary, there may be a case where the method cannot support various documents requested by the user.

### SUMMARY OF THE INVENTION

An object of present invention is to solve the problems and to increase printing speed of an image forming apparatus.

The object can be achieved by an image forming apparatus, including:

an image reading unit configured to read an image from a document;

a read mode setting receiving unit configured to receive setting of a read mode; and

a read area change unit configured to change an area of the document from which the image reading unit reads an image based on the setting of the read mode.

In the image forming apparatus, the read area change unit may reduce the area by the same distance for each of the top, bottom, left and right sides of the document. In addition, the image forming apparatus may further include a read density change unit configured to change an image density used when the image reading unit reads the image of the document based on the setting of the read mode.

The present invention can be also configured as an image forming apparatus, including:

a receiving unit configured to receive image data;

an outputting unit configured to output the image data received by the receiving unit;

an output mode setting receiving unit configured to receive setting of an output mode; and

an output area change unit configured to change an area to which the outputting unit outputs the image data based on the setting of the output mode.

According to the present invention, copying can be performed faster since time for reading the document or time for printing is reduced. In addition, a surface patter or small smudges or dusts on the document can be skipped by lowering the image density so that the time for copying can be further reduced.

### BRIEF DESCRIPTION OF THE DRAWINGS

Other objects, features and advantages of the present invention will become more apparent from the following detailed description when read in conjunction with the accompanying drawings, in which:

FIG. 1 is a functional block diagram showing a configuration of an image forming apparatus of an embodiment of the present invention;

FIG. 2 is a flowchart showing a process procedure for changing a reading area of a document according to a specified mode in the image forming apparatus of an embodiment of the present invention;

FIG. 3 is a figure for explaining an example of a reading area;

FIG. 4 is a flowchart showing a process procedure for changing a document reading density according to a specified mode in the image forming apparatus of an embodiment of the present invention;

FIG. 5 is a flowchart showing a copying process procedure for changing a document reading area according to a specified mode in which plural high speed modes are provided in the image forming apparatus of an embodiment of the present invention;

FIG. 6 is a flowchart showing a copying process procedure for contracting the document reading area uniformly for each of the top, bottom, left and right sides of the document in a high speed mode in which a plurality of high speed modes are provided in the image forming apparatus of an embodiment of the present invention;

FIG. 7 is a flowchart showing a copying process procedure for specifying a reading area of the document in a high speed mode in which a plurality of high speed modes are provided in the image forming apparatus of an embodiment of the present invention;

FIG. 8 is a flowchart showing a copying process procedure for changing a printing area in a mode in which a plurality of high speed modes in the image forming apparatus of an embodiment of the present invention;

FIG. 9 is a flowchart showing a copying process procedure for contracting the printing area uniformly for each of the top, bottom, left and right sides in a high speed mode in which a plurality of high speed modes are provided in the image forming apparatus of an embodiment of the present invention;

FIG. 10 is a flowchart of a copying process procedure for specifying a printing area in a high speed mode in which a plurality of high speed modes are provided in the image forming apparatus of an embodiment of the present invention.

### DETAILED DESCRIPTION OF THE PREFERRED EMBODIMENTS

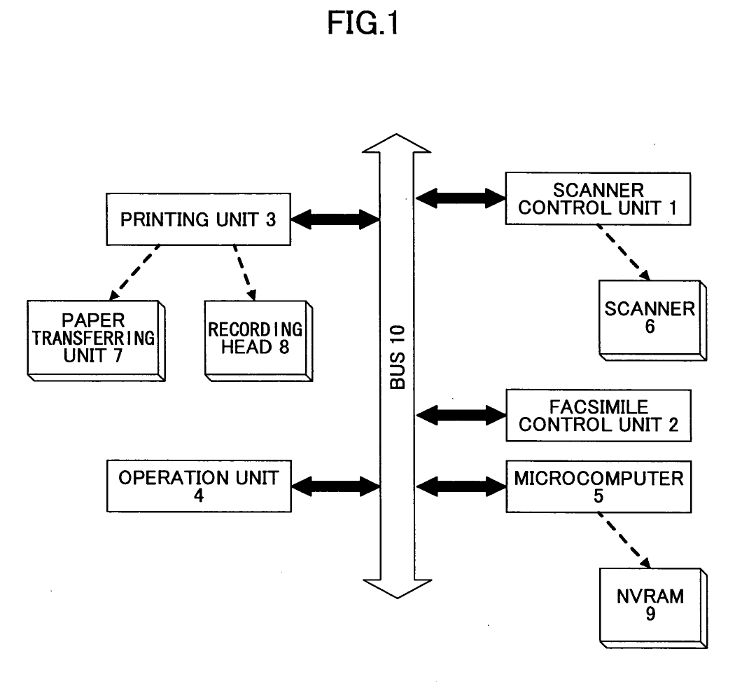

In the following, embodiments of the present invention are described with reference to FIGS. 1-10.

In this embodiment of the present invention, an image forming apparatus using an inkjet recording scheme is disclosed. The image forming apparatus controls an image reading unit so as to read an inner area compared with a normal read area in response to a high speed mode being specified. More particularly, the image forming apparatus controls the image reading unit so as to read the document by narrowing the read area by the same distance for each of the top, bottom left and right sides.

FIG. 1 is a functional block diagram showing a configuration of the image forming apparatus of the embodiment of the present invention. As shown in FIG. 1, the image forming apparatus includes a scanner control unit 1, a facsimile control unit 2, a printing unit 3, an operation unit 4, a microcomputer 5, a scanner 6, a paper transferring unit 7, a recording head 8, a NVRAM 9, and a bus 10.

The scanner control unit 1 is for controlling the scanner 6 for reading document data. The facsimile control unit 2 is for realizing a facsimile function. The printing unit 3 is an inkjet control unit for rendering a raster image and transferring a recording paper to perform printing. The operation unit 4 is a part used by a user for operating the image forming apparatus. The microcomputer 5 is for controlling the whole of the image forming apparatus. The scanner 6 is for optically reading a document image. The paper transferring unit 7 is for transferring a printing paper. The recording head 8 is a printing head of an inkjet recording scheme. The NVRAM 9 is a nonvolatile memory 9 for storing setting data and the like. The bus 10 is for transferring data of each processing unit.

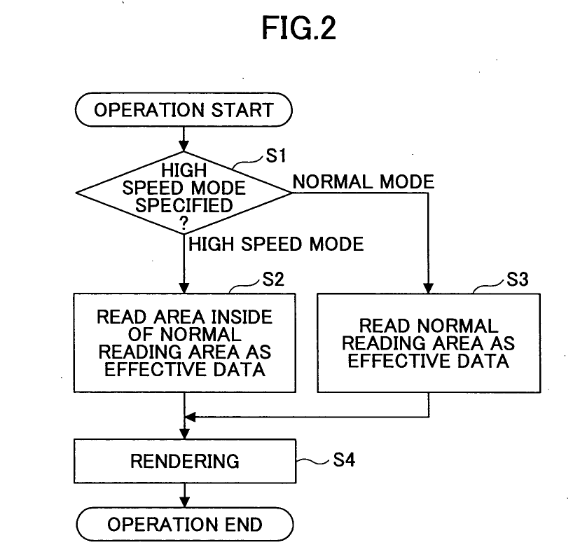

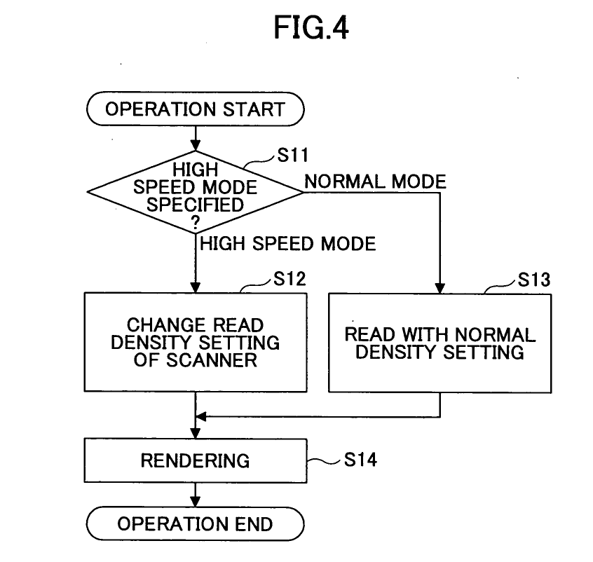

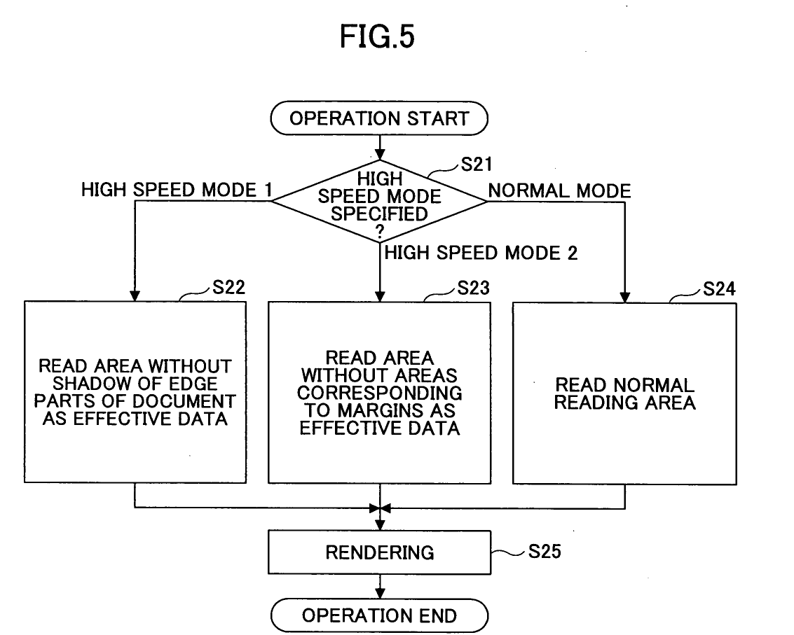

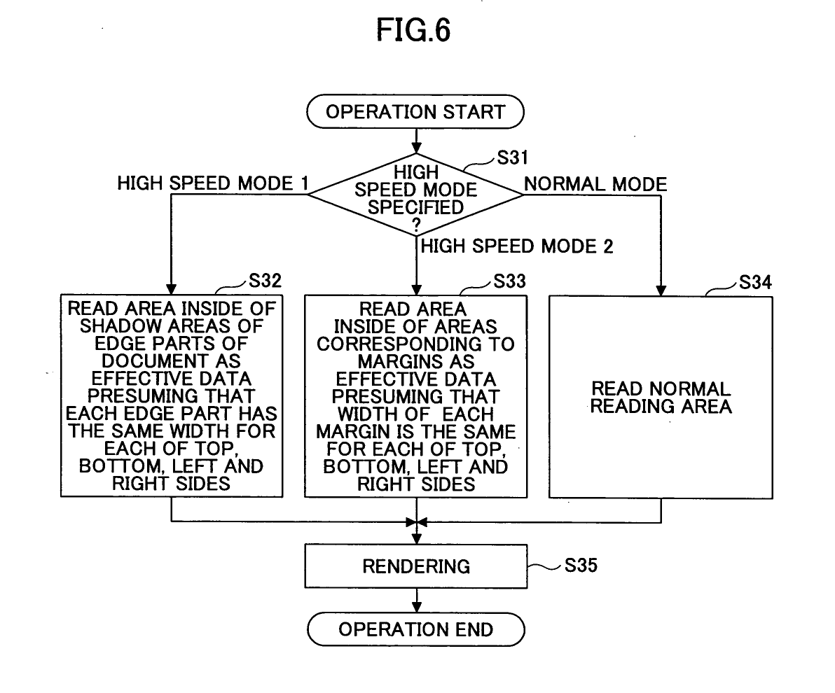

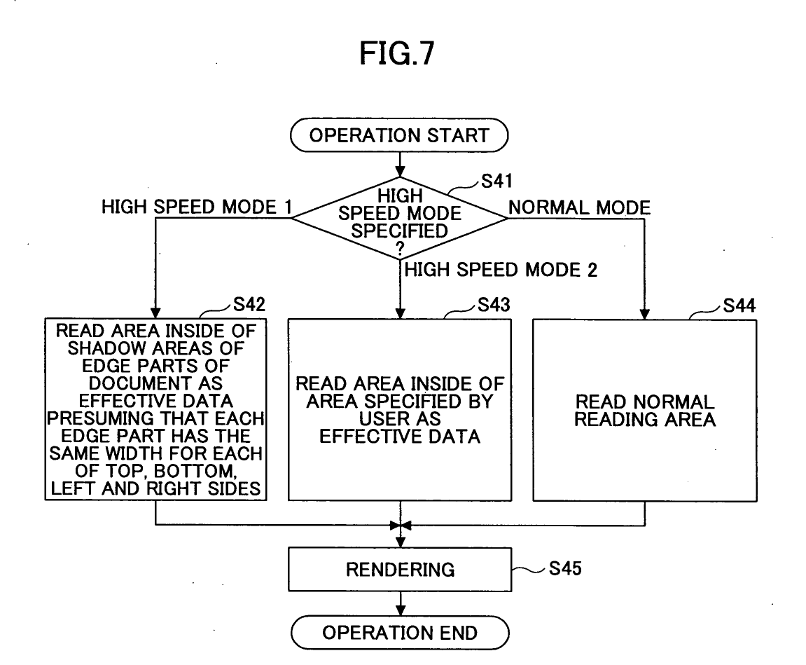

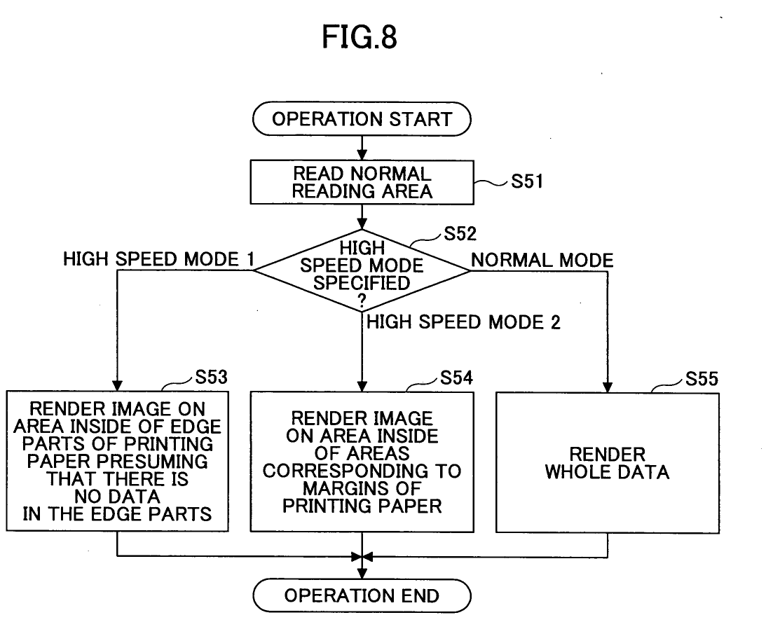

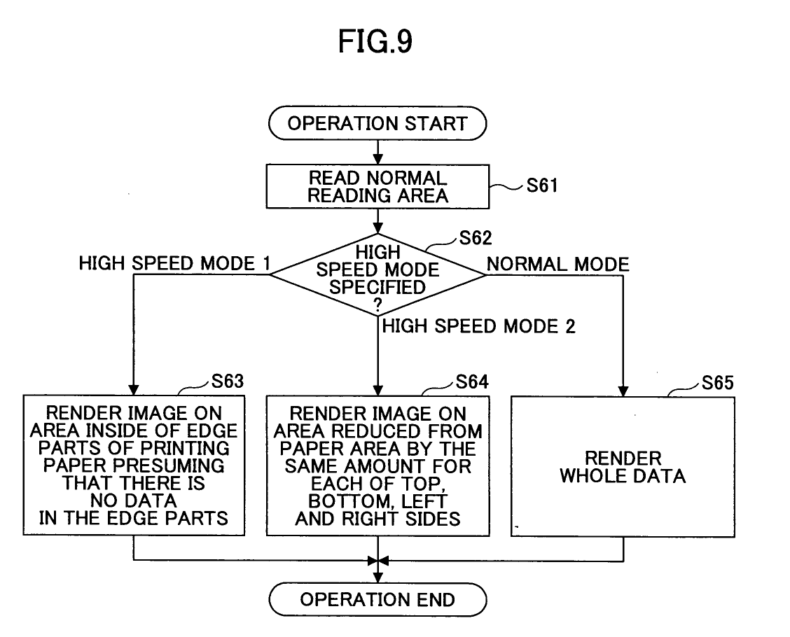

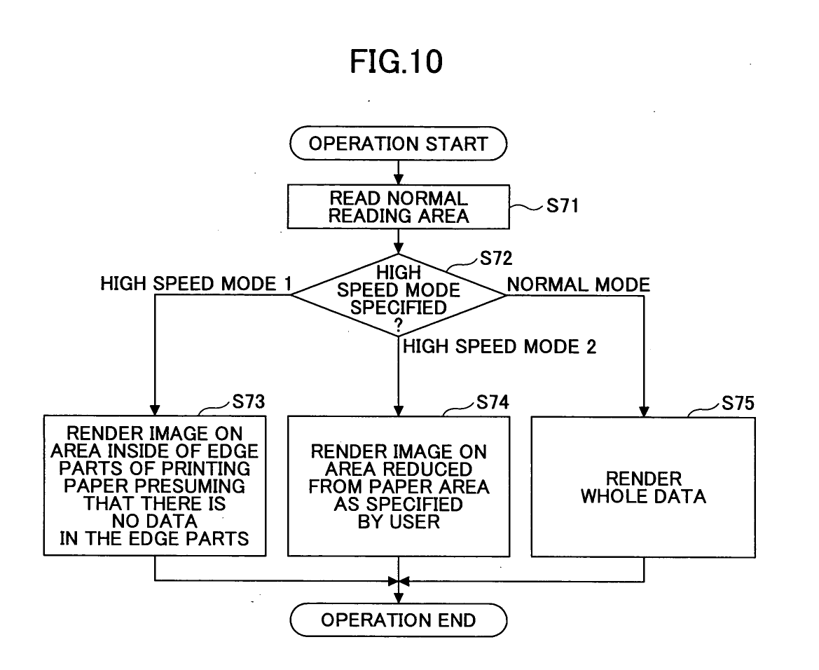

FIG. 2 is a flowchart showing a copying process procedure including a process for changing a reading area of a document according to a specified mode. FIG. 4 is a flowchart showing a copying process procedure including a process for changing a reading density of a document according to a specified mode. FIG. 5 is a flowchart showing a copying process procedure including a process for changing a reading area of a document according to a specified mode in which plural high speed modes are provided. FIG. 6 is a flowchart showing a copying process procedure including a process for contracting the reading area of the document uniformly for each of the top, bottom, left and right sides of the document in which a plurality of high speed modes are provided. FIG. 7 is a flowchart showing a copying process procedure including a process for specifying a reading area of the document according to a specified mode in which a plurality of high speed modes are provided. FIG. 8 is a flowchart showing a copying process procedure including a process for changing a printing range of a paper according to a specified mode in which a plurality of high speed modes are provided. FIG. 9 is a flowchart showing a copying process procedure including a process for contracting the printing area uniformly for each of the top, bottom, left and right sides according to a specified mode in which a plurality of high speed modes are provided. FIG. 10 is a flowchart of a copying process procedure including a process for specifying a printing area according to a specified mode in which a plurality of high speed modes are provided.

Functions and operation of the image forming apparatus of this embodiment configured in the above-mentioned way are described. Especially, a copying mechanism of the image forming apparatus is described. First, outline of the function of the image forming apparatus is described with reference to FIG. 1. The scanner control unit 1 controls the scanner 6 to read document data. The scanner 6 stores light reflected from the document into a photoelectric element such as a CCD so as to read an image having gradation. When sending a facsimile, the image forming apparatus reads an image with the scanner control unit 1 and sends the image under control of the facsimile control unit 2. When receiving facsimile data, the facsimile data received by the facsimile control unit 2 is sent to the inkjet control unit (printing unit 3) to print an image. The inkjet control unit (printing unit 3) renders a raster image and transfers a recording paper to perform printing. The user operates the operating unit 4 to specify a high speed mode or a normal mode.

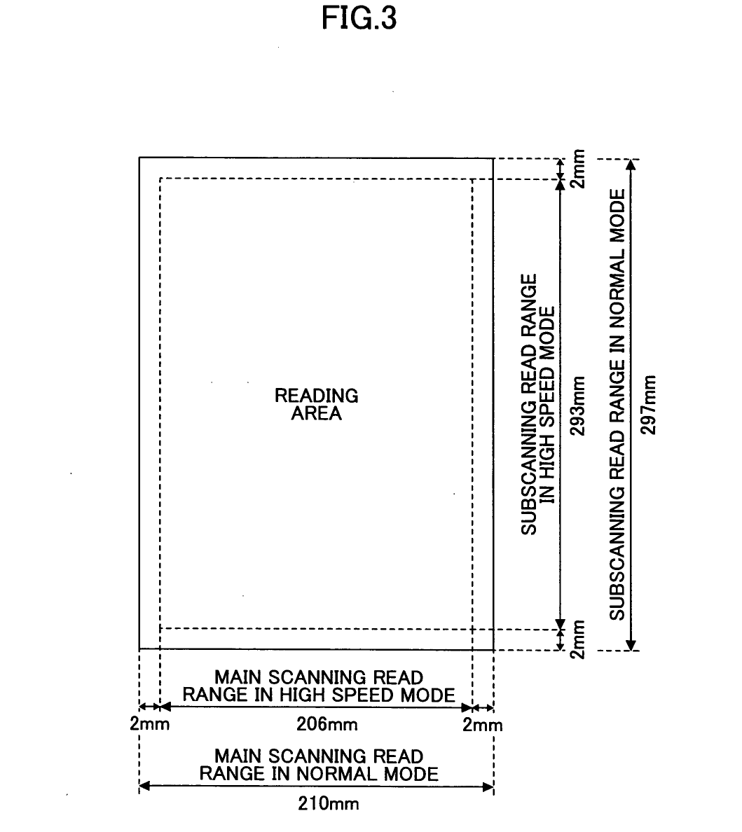

Next, a process procedure when reading a predetermined narrow area in the high speed mode is described with reference to FIG. 2. In step 1, the image forming apparatus checks whether the high speed mode is specified. When the user specifies the high speed mode at the operation unit 4, the scanner control unit 1 controls the scanner 6 to read an area that is narrower than a normal reading area and that is an inner area of a predetermined range. As shown in FIG. 3, Normally, a range of 210 mm is read in main scanning direction. On the other hand, in this step 2, a range of 206 mm is read by skipping 2 mm from each of the left side and the right side, for example. In addition, a range of 297 mm is read in subscanning direction normally. On the other hand, in this step 2, a range of 293 mm is read by skipping 2 mm for each of the top and bottom sides. Therefore, the normal reading area of 210 mm×297 mm is changed to a reading area of 206 mm×293 mm. When the user specifies a normal mode, the scanner control unit 1 controls the scanner 6 to read a normal reading area of the document in step 3. In step 4, rendering is performed.

In the high speed mode, since data of 2 mm is lacking on each of the top, bottom, left and right sides, the inkjet control unit (printing unit 3) prints an image on an area reduced inside by 2 mm on each of the top, bottom, left and right sides when printing. When reading, data in an area reduced inside by 2 mm on each side is determined to be effective data and an area outside of the effective data is set to be white data. The inkjet control unit (printing unit 3) prints data as 210 mm×297 mm size data. But, since there is no data on the outside area of 2 mm, the printing speed can be increased. Since there is no data on the left and right sides, the range where the ink discharging nozzle moves can be reduced, so that the time for printing in the main scanning direction can be reduced. Therefore, time interval for paper feeding in the subscanning direction is reduced so that the printing speed can be increased. In addition, there is no data on each of the top and bottom sides, the paper can be skipped to a position at which first printing is performed in the main scanning direction, so that the number of times for performing main scanning can be reduced. Accordingly, only by specifying the high speed mode by the user, the printing speed can be increased easily with high reliability.

Next, a process procedure for reducing a reading density in the high speed mode is described with reference to FIG. 4. In step 11, the image forming apparatus checks whether the high speed mode is specified. When the user specifies the high speed mode at the operation unit 4, the scanner control unit 1 controls the scanner 6 to read a document with a predetermined density lighter than a normal reading density. That is, by reducing the reading density, smudges or the surface pattern of the document are not read as data. For specifying the density, the user may specify the density. Alternatively, the density may be automatically changed to the lowest density. However, when the user specifies the high speed mode after specifying a density, the automatic change of the density is not performed. When the user specifies a normal mode, the scanner control unit 1 controls the scanner 6 to read the document with a normal reading density. Procedure after that is the same as that of FIG. 2. Accordingly, small smudges, dusts or the surface pattern of the document can be skipped. Therefore, since an originally white part of the document is recognized to be white, the area in which the ink discharging head moves can be kept to fall within an area of data to be essentially printed. Therefore, only by specifying the high speed mode by the user, the printing speed can be further increased.

Next, a process procedure when a plurality of high speed modes are provided is described with reference to FIG. 5. When there are a plurality of high speed modes that can be specified by the user, setting of a reading area is performed in the following way, for example. In a high speed mode 1, when reading a document, the image forming apparatus is controlled not to read an edge part of the document where an image, such as a shadow caused by thickness of the document, is apt to occur. Alternatively, even when such data is read, the data can be overwritten with white data. In a high speed mode 2, data in an area further reduced inside from the area of the high speed mode 1 is read. Since there is a white space area in a document, the area further reduced from the area where the shadow is apt to occur can be read. Alternatively, an edge part of an area that is read is overwritten with white data.

In step 21, the image forming apparatus checks a mode that is specified. When the high speed mode 1 is specified, the scanner control unit 1 controls the scanner 6 such that an area where there is no image such as shadow on an edge part of the document becomes effective data in step 22. When the high speed mode 2 is specified, the scanner control unit 1 controls the scanner 6 to read the document such that an area without the white space area becomes the effective data. When the user specifies the normal mode, the scanner control unit 1 controls the scanner 6 so as to read a normal reading area in step 24. Procedure after that is the same as the procedure shown in FIG. 2. Accordingly, setting in which the speed can be increased minimally and setting in which the speed can be largely increased are provided so that convenience of the user can be improved.

Next, a process procedure is described for reading an area from which the same width is reduced for each of the top, bottom, left and right sides in which a plurality of high speed modes are provided with reference to FIG. 6. The image forming apparatus checks a mode that is specified in step 31. When the user specifies a high speed mode 1 at the operation unit 4, the scanner control unit 1 controls the scanner 6 so as to read the document such that an area without an image of shadow and the like on the edge of the document becomes effective data in step 32. At this time, a same amount is reduced inward for each of the top, bottom, left, and right sides. When the user specifies a high speed mode 2, the scanner control unit 1 controls the scanner 6 to read the document such that an area without areas corresponding to white space (margin) becomes effective data in step 33. At this time, a same amount is reduced inward for each of the top, bottom, left, and right sides. When the user specifies a normal mode, the scanner control unit 1 controls the scanner 6 to read a normal reading area in step 34. Procedure after that is the same as that of FIG. 2. Since the image forming apparatus is controlled not to read image data of the same width for each of the top, bottom, left and right sides, the user can easily understand constraints when specifying the high speed mode. That is, the user can easily understand that edge areas of the document are not read similarly for each of the top, bottom, left and right sides so as to have no hesitation in deciding placement of the document.

Next, a process procedure when specifying a reading area in a high speed mode is described with reference to FIG. 7. In this process, a mode for the user to be able to specify a reading area is provided in a high speed mode. When this mode is selected, an area can be specified by specifying each of the top, bottom, left and right sides. Alternatively, an amount by which an area is reduced, from each edge of the document, similarly for each of the top, bottom, left and right sides can be specified. In addition, by storing the setting information in the nonvolatile memory, the high speed mode with the same setting can be specified next time. Since the user can specify the reading area, the user can specify an area applicable for a document the user often uses, so that convenience for the user can be improved.

The image forming apparatus check a mode that is specified in step 41. When the user specifies a high speed mode 1 at the operation mode 4, the scanner control unit 1 controls the scanner 6 so as to read the document such that an area without an image of shadow and the like on the edge of the document becomes effective data. At this time, a same amount is reduced inward for each of the top, bottom, left, and right sides. When the user specifies a high speed mode 2 and the user specifies a reading area by specifying the top, bottom, left and right sides, the setting information is stored in the nonvolatile memory in step 43. The scanner control unit 1 controls the scanner 6 to read the document such that the specified area becomes effective data. When the user specifies a normal mode, the scanner control unit 1 controls the scanner 6 to read a normal reading area in step 44. Procedure after that is the same as that of FIG. 2.

Next, a process procedure when writing is performed in a high speed mode is described with reference to FIG. 8. When the user specifies the high speed mode, the inkjet control unit (printing unit 3) determines a printing area presuming that there is data only in a predetermined area, that is, presuming that at least data outside of the range can be neglected. Since rendering process can be performed without handling data on the left and right sides, the range where the ink discharging head moves narrow so that time for printing in the main scanning direction can be reduced. By performing such printing in the main scanning direction, time interval for paper feeding in the subscanning direction can be reduced so that the printing speed can be increased. In addition, since rendering process can be performed presuming that there is no data on the top and bottom sides, the paper can be skipped to a position at which first printing in the main scanning direction is performed, so that the number of times of main scanning can be reduced. Accordingly, only by specifying the high speed mode by the user, the printing speed can be increased easily with high reliability. In addition, setting in which the speed is increased minimally and setting in which the speed is largely increased are provided so that convenience of the user can be improved.

In step 51, the scanner control unit 1 controls the scanner 6 so as to read a normal reading area. The image forming apparatus checks a mode that is specified in step 52. When a high speed mode 1 is specified, the inkjet control unit (printing unit 3) renders an image of an area inside of edge parts of a paper presuming that there is no data on the edge parts of the paper area in step 53. When the high speed mode 2 is specified, the inkjet control unit (printing unit 3) renders an image of an area inside of areas corresponding to white space (margins) of the document in step 54. When a normal mode is specified, the inkjet control unit (printing unit 3) renders an image of the whole area of the paper.

Next, a process procedure is described for printing data on an area from which the same amount is reduced for each of the top, bottom, left and right sides when the high speed mode is selected with reference to FIG. 9. When the user specifies a high speed mode, the inkjet control unit (printing unit 3) determines a printing area presuming that there is data only in a predetermined area, that is, presuming that at least data outside of the area can be neglected, and the inkjet control unit (printing unit 3) prints an image in an area in which the same amount is reduced, from the paper area, for each of the top, bottom, left and right sides. In step 61, the scanner control unit 1 controls the scanner 6 so as to read a normal reading area. The image forming apparatus checks a mode that is specified in step 62. When a high speed mode 1 is specified, the inkjet control unit (printing unit 3) renders an image on an area inside of the edge parts of the paper area presuming that there is no data on edge parts of the paper area. When a high speed mode 2 is specified, the inkjet control unit (printing unit 3) renders an image on a area in which areas corresponding to white space (margins) are reduced from the paper area. When a normal mode is specified, the inkjet control unit (printing unit 3) renders the whole data. Accordingly, the user can easily understand the constraints in the high speed mode that there is a possibility that data is not printed similarly for each of the top, bottom, left and right sides. That is, the user can easily understand that there is a possibility that each of edge parts of the printing paper is not printed similarly irrespective of orientation of the printing paper.

Next, a process procedure when printing an image on an area specified in a high speed mode is described with reference to FIG. 10. A mode in which the user can specify a printing area is provided in the high speed mode. When the mode is selected, a printing area can be specified by specifying each of the top, bottom, left and right sides. Alternatively, an amount by which an area is reduced from each edge of a printing paper similarly for each of the top, bottom, left and right sides can be specified. In addition, by storing the setting information in the nonvolatile memory, the high speed mode with the same setting can be specified next time. In step 71, the scanner control unit 1 controls the scanner 6 so as to read a normal reading area. In step 72, the image forming apparatus checks a mode that is specified. When a high speed mode 1 is specified, the inkjet control unit (printing unit 3) controls the scanner 6 so as to render an image on an area inside of the edge parts presuming that there is no data on the edge parts of the paper area in step 73. When a high speed mode 2 is specified, the inkjet control unit (printing unit 3) controls the scanner 6 so as to render an image on an area inside of the paper area that is specified in step 74. At this time, printing is performed on an area in which the same amount is reduced from the paper area for each of the top, bottom, left and right sides. When a normal mode is specified, the whole data are rendered. Since the user can set a printing range, the user can set an area applicable for a document the user often uses or applicable for received data of facsimile, so that convenience for the user can be improved.

As mentioned above, according to the embodiments of the present invention, since the image forming apparatus of the inkjet recording scheme is configured so as to reading an area narrower than a normal reading area in response to a high speed mode being selected, the printing speed can be increased.

By the way, although the embodiments take the image forming apparatus using the inkjet recording scheme as an example, the present invention is not limited to the image forming apparatus, and the present invention can be applied to image forming apparatuses using other schemes.

The present invention is not limited to the specifically disclosed embodiments, and variations and modifications may be made without departing from the scope of the present invention.

The present application contains subject matter related to Japanese patent application No. 2005-270677, filed in the JPO on Sep. 16, 2005, the entire contents of which are incorporated herein by reference.

What is claimed is:

1. An image forming apparatus, comprising:
an image reading unit configured to read an image from a document;
a read mode setting receiving unit configured to receive setting of a read mode; and
a read area change unit configured to change an area of the document from which the image reading unit reads an image based on the setting of the read mode.

2. The image forming apparatus as claimed in claim 1, wherein the read area change unit reduces the area by the same distance for each of the top, bottom, left and right sides of the document.

3. The image forming apparatus as claimed in claim 1, further comprising a registering unit configured to register a parameter, wherein the read area change unit changes the area based on the parameter registered in the registering unit.

4. The image forming apparatus as claimed in claim 1, further comprising a read density change unit configured to change an image density used when the image reading unit reads the image of the document based on the setting of the read mode.

5. An image forming apparatus, comprising:
a receiving unit configured to receive image data;
an outputting unit configured to output the image data received by the receiving unit;
an output mode setting receiving unit configured to receive setting of an output mode; and
an output area change unit configured to change an area to which the outputting unit outputs the image data based on the setting of the output mode.

6. The image forming apparatus as claimed in claim 5, wherein the output area change unit reduces the area by the same distance for each of the top, bottom, left and right sides of the document.

7. The image forming apparatus as claimed in claim 5, further comprising a registering unit configured to register a parameter, wherein the output area change unit changes the area based on the parameter registered in the registering unit.
